(19) United States
(12) Patent Application Publication
(10) Pub. No.: US 2026/0102743 A1
(43) Pub. Date: Apr. 16, 2026

(54) BITUMINOUS WATERPROOFING MEMBRANE COMPRISING A RECYCLED BITUMINOUS BINDER, A REINFORCEMENT AND A REJUVENATOR

(71) Applicant: Imperbel, Beersel (BE)

(72) Inventors: Matthieu RETAILLEAU, Beersel (BE); Amandine MATAGNE, Beersel (BE); Jean Pierre DUFOUR, Beersel (BE)

(21) Appl. No.: 19/111,592

(22) PCT Filed: Sep. 12, 2023
(86) PCT No.: PCT/EP2023/075038

§ 371 Date: Mar. 13, 2025

(30) Foreign Application Priority Data
Sep. 14, 2022 (BE) BE2022/5731

(51) Int. Cl. B01D 71/74; B01D 65/02; B01D 67/00; B01D 69/10; B01D 71/04; B01D 71/26; B01D 71/28; B01D 71/48

(52) U.S. Cl. CPC B01D 71/74; B01D 65/02; B01D 67/002; B01D 69/1071; B01D 69/108; B01D 71/04; B01D 71/26; B01D 71/281; B01D 71/48; B01D 2321/168; B01D 2323/54; B01D 2325/38; B01D 2325/40

(57) ABSTRACT

A recyclable waterproofing membrane has a bituminous binder with a recycled bituminous binder (RBB), optionally a fresh polymer and optionally fresh bitumen and a reinforcement. The bituminous binder has a rejuvenator selected from the group consisting of bio-based oils and/or mineral oils, such as plant-based, pine-oil based or vegetable-oil-based. The recycled bituminous binder is obtained by grinding and melting waterproofing membranes with bituminous binder, polymers and a reinforcement.

### CROSS-REFERENCE TO RELATED APPLICATIONS

This application is a U.S. National Phase Application under 35 U.S.C. 371 of International Application No. PCT/EP2023/075038, filed Sep. 12, 2023, which claims priority to Belgium Application No. BE2022/5731, filed Sep. 14, 2022. The entire disclosures of the above applications are incorporated herein by reference.

### FIELD OF THE DISCLOSURE

This disclosure relates to the field of carbon-neutrality through recycled bituminous waterproofing membranes. Moreover, the disclosure relates to the improvements of physical properties and processability of recycled bituminous binders through the use of rejuvenators. The rejuvenators, preferably, are bio-based. Impressively, through the addition of certain rejuvenators, the cold flexibility of the recycled bituminous binder has been improved by 180% or even more. Moreover, the viscosity has been further reduced to enable a better processability of the binder. On top of that, the penetrability has also been significantly increased.

### BACKGROUND

Recycling of bituminous waterproofing membranes is known from EP3853306B1 to the Applicant (Imperbel) through grinding and melting. EP3852932B1 to the Applicant describes a process of recycling bituminous membranes comprising grinding and melting as well as a mixing of the melted product with a fresh bitumen. However, the level of recycled bitumen in bituminous waterproofing membranes is currently limited by the processability of the binder and the physical properties of the bituminous waterproofing membrane obtained, especially the cold flexibility of the bituminous waterproofing membrane.

Rejuvenators for recycled asphalt have already been described for road applications or waterproofing shingles. Road applications include use of bitumen with aggregate such as sand and gravel. Shingles are not considered to be a membrane as they are typically smaller pieces that must be laid in overlapping fashion both across and down a roof. Furthermore they are suitable only for pitched roofs and typically will not function for rainwater runoff on a flat roof or a roof with a slope of less than 10 degrees, for example less than 5 degrees in the water run-off direction.

However, generally, these documents do not describe the specific use of rejuvenators in waterproofing membranes comprising recycled bituminous binders, polymers, and reinforcements.

For example, EP3256514A1 to Soprema describes the mixing of aged bitumen with cooking oil in a proportion of 4% to 5% of the volume of bitumen.

It is, therefore, an object of the present disclosure to provide bituminous waterproofing membranes with an increased level of recycled bituminous binder.

It is a further object of the present disclosure to reduce the carbon footprint of bituminous waterproofing membrane production.

Moreover, it is an object of the present disclosure to reduce the production costs of bituminous waterproofing membranes whilst maintaining their performance, as for example expressed in flexibility, or penetrability, and even improving the processability via the reduction of viscosity (during production of bituminous waterproofing membranes using recycled bituminous binders).

### SHORT DESCRIPTION OF THE DISCLOSURE

The present inventors have found that the content of recycled bituminous binder in waterproofing membranes, in particular of bituminous roofing membranes, may be considerably increased by adding a small amount of rejuvenator(s) as compared to the total weight of the bituminous binder in recyclable waterproofing membranes. For example amounts up to about 30% by weight, such as up to about 35% by weight, including up to about 40% by weight of recycled bituminous binder can be used, based on the total weight of bituminous binder. Indeed with the present disclosure amounts up to about 70% by weight, such as up to about 80% by weight, including up to about 90% for example up to 95% by weight of recycled bituminous binder can be used, based on the total weight of bituminous binder.

Accordingly, the present disclosure provides a recyclable waterproofing (roofing) membrane, comprising:
a. a bituminous binder comprising a recycled bituminous binder (RBB), optionally a fresh polymer and optionally fresh bitumen; and
b. a reinforcement;
wherein the bituminous binder comprises a rejuvenator selected from the group consisting of bio-based oils and/or mineral oils, preferably the rejuvenator is bio-based, more preferably plant-based, even more preferably the rejuvenator is pine-oil based or vegetable-oil-based;
optionally wherein the recycled bituminous binder is obtained by grinding and melting waterproofing membranes comprising bituminous binder, polymers and a reinforcement.

Desirably the recyclable waterproofing (roofing) membrane comprises a recycled oil.

Optionally, the weight ratio of the rejuvenator to recycled bituminous binder (Rejuvenator/RBB) is from 0.005 to 0.200, preferably from 0.010 to 0.150, even more preferably from 0.015 to 0.100. (The rejuvenator is a distinct component from other possible components of the bituminous binder described herein.)

The polymer may be a polyolefin or a styrene-based polymer.

The amount of added polyolefin polymer in the bituminous binder may be from 0.5 w % to 15 w %, such as from 1 w % to 15 w %, preferably from 0.5 w % to 13 w % such as from 1.5 w % to 13 w %, even more preferably from 0.5 w % to 11 w % such as from 3 w % to 11 w % as compared to the total weight the bituminous binder.

The amount of added styrene-based polymer in the bituminous binder may be from 0.3 w % to 8 w %, preferably from 0.5 w % to 7 w %, even more preferably from 0.5 w % to 6 w %, such as from 1 w % to 6 w % as compared to the total weight of the bituminous binder.

The amount (concentration) of the rejuvenator is desirably from 0.4 w % to 15 w %, preferably from 0.8 w % to 12 w %, even more preferably from 1.2 w % to 8 w % as compared to the total weight of the bituminous binder.

Optionally, the bituminous binder further comprises recycled oil. This oil may be added to increase flexibility in the membrane and reduce viscosity of the bituminous binder

The skilled person will know that increasing flexibility in the membrane and/or reducing viscosity of the bituminous binder, while desirable, does not mean that any agent or component that achieves one or both of these functions acts as a rejuvenator. Within the present disclosure a rejuvenator is an agent/component that acts as a dispersant or compatibiliser and as such is capable of breaking or disrupting the interactions or intermolecular associations between the materials present in the RBB such as the intermolecular associations between asphaltenes present (for example due to oxidation). Such action can be considered as a “remobilization” or “rejuvenation” or “regeneration” of the RBB and preferably also acts to rejuvenate” or “regenerate” any polymer within the RBB.

The bituminous binder optionally further comprises recycled oil in an amount from 0.5 w % to 20 w % such as from 1 w % to 20 w %, preferably from 1 w % to 18 w % such as from 1.5 w % to 18 w %, even more preferably from 1.5 w % to 16 w % such as from 2 w % to 16 w % as compared to the total weight of the bituminous binder.

Within the scope of the present disclosure is a recyclable waterproofing membrane, comprising:
a. a bituminous binder comprising a recycled bituminous binder (RBB), wherein the recycled bituminous binder comprises a polymer; recycled oil; a rejuvenator; and filler; and
b. a reinforcement.
   Desirably such a recyclable waterproofing membrane does not include either of fresh polymer or fresh bitumen.

Optionally, the thickness, d, of the recyclable waterproofing membrane is between 1 mm and 6 mm, preferably between 1.5 mm and 5 mm, such as between 2 mm and 5 mm, and even more preferably between 2 mm and 5 mm, such as between 2.5 mm and 5 mm.

The reinforcement will generally be in the form of a layer, for example in the form of a mat. The reinforcement provides the structural integrity to the membrane.

Optionally, the reinforcement is a non-woven fabric.

The reinforcement may be made of polyester, glass fiber or a combination thereof.

The bituminous binder may be obtained by a process according to the disclosure comprising the steps of:
Finely grinding bituminous waterproofing membranes; wherein the bituminous waterproofing membranes comprise bituminous binder, polymers and a reinforcement;
Introducing the finely ground batch into a recycling unit having at least a rotor and a stator and a micronization chamber, wherein the fine ground batch is heated and melted by shear strength upon the operation of the stator, rotor and micronization chamber;
Optionally, diluting the melted product in a mixing tank containing fresh bitumen and/or recycled oil up to a factor 2 at a residence temperature comprised between 160° C. and 200° C. wherein a rejuvenator is added to decrease the viscosity at 180° C., so that after the rejuvenator is added the viscosity is preferably from 5000 mPa·s to 25000 mPa·s, preferably the viscosity is from 7500 mPa·s to 20000 mPa·s, preferably from the viscosity is from 10000 mPa·s to 15000 mPa·s; or
Optionally, feeding the melted product in a mixing tank containing fresh bitumen between 15 w % and 50 w % at a residence temperature comprised between 160° C. and 200° C. until the melted product is between 50 w % and 95 w %, wherein a rejuvenator is added to decrease the viscosity at 180° C., so that after the rejuvenator is added the viscosity is preferably from 5000 mPa·s to 25000 mPa·s, preferably the viscosity is from 7500 mPa·s to 20000 mPa·s, preferably from the viscosity is from 10000 mPa·s to 15000 mPa·s.

A membrane of the disclosure can be can be made without the addition of any fresh bitumen, and a process of the invention for making a membrane, can be carried out without the addition of any fresh bitumen. In such a case the bitumen comes from the RBB.

Additionally or alternatively, a membrane of the disclosure can be can be made without the addition of any fresh polymer, and a process of the disclosure for making a membrane can be carried out without the addition of any fresh polymer where the RBB comprises polymer.

The disclosure also provides a process for improving the performance of recyclable waterproofing membranes comprising a recycled bituminous binder and a reinforcement, preferably for one or more of:
Regenerating the polymer; (this may be considered recompatibilisation) [—this may take the form of increasing the dispersion of the polymer within the bituminous binder so that the polymer can be part of a continuous phase (this does not occur (to a desired extent for example does not fully occur) without the rejuvenator, and as described herein this may be because the rejuvenator can be utilized to promote phase inversion)]
Decreasing the viscosity, preferably for decreasing the viscosity of the bituminous binder comprising the RBB wherein the viscosity is decreased to be 5000 mPa·s to 25000 mPa·s, preferably from 5000 mPa·s to 20000 mPa·s, preferably from 5000 mPa·s to 15000 mPa·s; (These values are measured as set out below under the heading Viscosity)
Improving the cold flexibility, preferably for improving the cold flexibility of the bituminous binder comprising the RBB wherein the cold flexibility is improved, to a value in the range from −5° C. to −35° C., even more preferably from −10° C. to −35° C. and even more preferably from −15° C. to −35° C.; (These values are measured as set out below under the heading Flexibility) or
Increasing the penetrability at 25° C., for example by increasing the penetrability of the bituminous binder comprising the RBB at 25° C., preferably from 25 dmm to 40 dmm, preferably from 27 dmm to 37 dmm, and even more preferably from 30 dmm to 35 dmm; (These values are measured as set out below under the heading Penetrability. Dmm=decimillimetre),
wherein a rejuvenator is added to a recycled bituminous binder,
wherein the rejuvenator is selected from the group consisting of bio-based oils and mineral oils, preferably the rejuvenator is bio-based, more preferably plant-based, even more preferably the rejuvenator is pine-oil based or vegetable-oil-based, and optionally,
wherein the recycled bituminous binder is obtained by grinding and melting waterproofing membranes comprising bituminous binder, polymers and a reinforcement.

The present disclosure also relates to the use of a rejuvenator preferably for one or more of:
Regenerating the polymer; (this may be considered recompatibilisation) [—this may take the form of increasing the dispersion of the polymer within the bituminous binder so that the polymer can be part of a continuous phase (this does not occur (to a desired extent for example does not fully occur) without the rejuvenator, and as described herein this may be because the rejuvenator can be utilized to promote phase inversion)]
Decreasing the viscosity, preferably for decreasing the viscosity of the bituminous binder comprising the RBB wherein the viscosity is decreased to be 5000 mPa·s to 25000 mPa·s, preferably from 5000 mPa·s to 20000 mPa·s, preferably from 5000 mPa·s to 15000 mPa·s; (These values are measured as set out below under the heading Viscosity)
Improving the cold flexibility, preferably for improving the cold flexibility of the bituminous binder comprising the RBB wherein the cold flexibility is improved, to a value in the range from −5° C. to −35° C., even more preferably from −10° C. to −35° C. and even more preferably from −15° C. to −35° C.; (These values are measured as set out below under the heading Flexibility) or
Increasing the penetrability at 25° C., for example by increasing the penetrability of the bituminous binder comprising the RBB at 25° C., preferably from 25 dmm to 40 dmm, preferably from 27 dmm to 37 dmm, and even more preferably from 30 dmm to 35 dmm; (These values are measured as set out below under the heading Penetrability. dmm=decimillimetre)
in recycled bituminous binders,
wherein the rejuvenator is selected from the group consisting of bio-based oils and mineral oils, preferably the rejuvenator is bio-based, more preferably plant-based, even more preferably the rejuvenator is pine-oil based or vegetable-oil-based and optionally
wherein the recycled bituminous binder is obtained by grinding and melting waterproofing membranes comprising bituminous binder, polymers and a reinforcement.

It is known to a person skilled in the art that bitumen can be modified by mixing it with a polymer to form a modified bitumen. Such modified bitumen typically demonstrates one or more improved properties such as improved elasticity which can translate into improved elasticity and/or toughness in the membrane. Such modified bitumens are of interest in the present disclosure. The addition of a polymer to bitumen will lead to a phase inversion when the amount of the polymer is sufficient to obtain the phase inversion. The phase inversion typically corresponds to the formation of a polymeric matrix wherein bitumen is retained. When phase inversion occurs, this changes the bitumen from mainly having the behaviour of an elastic materials, to having mainly the properties of an elastic material. So it shows improved viscoelastic behaviour as improved elasticity which can translate into improved elasticity and/or toughness in the membrane.

The polymer forms a continuous phase (polymeric matrix) and the bitumen forms a dispersed phase. When the phase inversion occurs, the bitumen is retained into the polymeric matrix giving the viscoelastic properties and the stability to the composition comprising the bitumen and the polymer. The phase inversion phenomenon typically depends on the type of the polymer and the bitumen's composition.

Surprisingly with the present disclosure, it has been found that the rejuvenator can be utilized to promote phase inversion in a bituminous binder comprising a recycled bituminous binder (RBB) where the RBB comprises a polymer. This phase inversion can be achieved in the absence of any polymer other than the RBB polymer.

One of the benefits of the present disclosure is that bituminous membranes are recycled into bituminous membranes. Often in recycling downcycling occurs—that is a product when recycled is used for a different purpose because the recycled material is of lower quality and functionality than the original material. There is typically almost no downcycling with a product of the present disclosure as almost the entire membrane can be recycled.

Another major benefit of the present disclosure is that used bituminous membranes are recycled into new bituminous membranes without the requirement to separate the components of the used bituminous membranes from each other before reusing/recycling to manufacture the new bituminous membranes. (It will be appreciated that for example other materials, typically contaminants, which are inadvertently within the used bituminous membranes may be separated before or during a recycling process. For example metals may be removed as described herein.)

### SHORT DESCRIPTION OF THE DRAWINGS

FIG. 1 shows a schematic representation of the mechanism of action of rejuvenators in recycled bituminous binders. The rejuvenator disperses the agglomerated asphaltene molecules as shown in step 1. The rejuvenator also regenerates the polymer as shown in step 2 by improving/restoring the polymer/bitumen compatibility.

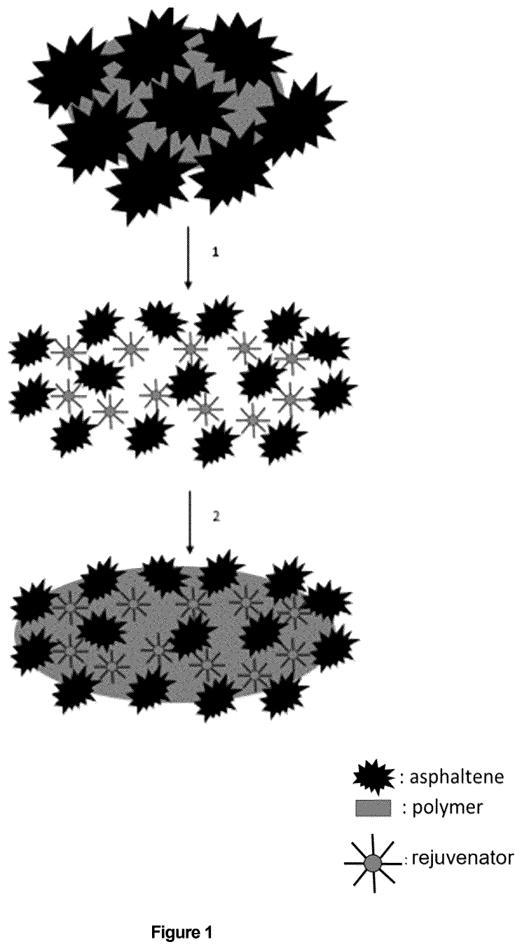

### DETAILED DESCRIPTION OF THE DISCLOSURE

The disclosure is now described in further detail.

### Waterproofing Membrane

Waterproofing is the process of making an object or structure waterproof or water-resistant so that it remains relatively unaffected by water or resisting the ingress of water, such as rain. Waterproofing membranes are systems that typically comprise of layer(s) of a waterproofing material, preferably a bituminous layer, and a reinforcement(s).

Waterproofing membranes may be used to waterproofing bridges, parkings or roofings.

### Bituminous Binder

The bituminous binder comprises the recycled bituminous binder, the rejuvenator and optionally fresh bitumen and optionally further additives.

All weight percentages (w % or wt %) relate to the total weight of the bituminous binder.

### Recycled Bituminous Binder (RBB)

Recycled bituminous binder can be derived from manufacturing waste, cut-off from installation sites or from aged waterproofing membranes.

The recycled bituminous binder may be partially or fully obtained through the method described in European Patent EP3853306B1 to the Applicant comprising:
A first grinding of a waste bituminous membrane in a knife shredder (5) to a mean particle size between 20 and 50 cm, preferably between 20 cm and 40 cm;
A second grinding to a mean particle size between 5 cm and 25 cm, preferably between 8 cm and 20 cm;
A third grinding to a particle size between 20 mm and 50 mm, preferably between 25 mm and 40 mm, more preferably between 27 mm and 35 mm;
Conveying on a vibrating sieve (12, 13) to remove dust and particles having a particle size d 100 of lower than 8 mm, preferably lower than 7 mm, more preferably less than 6 mm;
Separating metal pieces from non-metal pieces by application of Foucault current;
Introducing into a recycling unit having at least a rotor (15) and a stator (2) and a micronization chamber (20), wherein the bituminous membrane is heated and melted by shear strength upon the operation of the stator (2), rotor (15) and micronization chamber (20); and
Collecting a melted product.

The recycled bituminous binder may be further obtained through the method described in EP3852932B1 to the Applicant. It describes a process of recycling bituminous membrane comprising grinding and melting steps and a mixing step of said melted product with a fresh bitumen. In particular, the recycled bituminous binder may be obtained through a process comprising the steps of:
Finely grinding waste bituminous membranes,
Introducing into a recycling unit having at least a rotor and a stator and a micronization chamber, wherein the finely ground bituminous membranes are heated and melted by shear strength upon the operation of the stator, rotor and micronization chamber;
Optionally, feeding the melted finely ground bituminous membrane in a mixing tank containing fresh bitumen in an amount of 25 w % to 75 w %, preferably between 30 w % and 60 w % of the volume of the mixing tank at a residence temperature comprised between 160° C. and 200° C., preferably between 170° C. and 190° C., more preferably around 180° C., to a volume of 25 w % to 75 w %, preferably between 40 w % and 70 w % as compared to the volume of the mixing tank to obtain a recycled bitumen with a viscosity at 180° C. of 500 mPa·s to 45000 mPa·s.

### Fresh Bitumen

Optionally, the bituminous binder comprising the recycled bituminous binder further comprises fresh bitumen.

Fresh bitumen is understood to be bitumen that has not yet been used for the manufacturing of bituminous membranes. (Indeed the term “fresh” as applied to any component is understood to be a component that has not yet been used for the manufacturing of bituminous membranes.)

Fresh bitumen may have the following composition:

| Properties | Saturates | Aromatics | Resins | Asphaltenes |
|---|---|---|---|---|
| H/C | 2 | 1.4-1.6 | 1.4-1.7 | 0.9-1.6 |
| MW (g/mol) | 470-880 | 570-980 | 780-1400 | 800-3500 |
| Bitumen Fraction (%) | 5-20 | 40-65 | 30-50 | 5-25 |

Optionally, the bituminous binder comprises fresh bitumen, such as that having the properties above, in an amount from 0 w % to 75 w %, up to 75 w %, preferably from 0.5 w % to 50 w % such as from 2.5 w % to 50 w %, optionally from 5 w % to 50 w %, more preferably from 1.5 w % to 25 w % such as from 5 w % to 25 w % as compared to the total weight of the bituminous binder.

The bituminous binder comprising the recycled bituminous binder optionally does not comprise any fresh bitumen.

### Recyclability and Recycled Bitumen Reduce Carbon-Food Print and Costs

The recyclable waterproofing membrane is fully recyclable for example through the recycling or mixing process described in patent claim 1 of EP3852932B1 or patent claim 1 of EP3853306B1.

The recyclability reduces the carbon footprint of the recyclable waterproofing membrane of the present disclosure.

Furthermore, the recyclability is reducing waste which otherwise must be removed at high costs.

### Aging

Aging affects bitumen during the entire service life due to environmental stresses and the bitumen's exposure to air. Aging in particular leads to:
Physical and steric hardening;
Loss of low-weight components (volatiles) by evaporation; and
Oxidation.

### Rejuvenators

Rejuvenators are oil-based liquids, emulsions, or dispersions. Rejuvenators may be bio-based or mineral oil based.

Preferred rejuvenators are bio-based, more preferably plant-based, and even more preferably pine oil-based or vegetable-oil based.

Commercially available rejuvenators include:

| Commercial names and trademarks | Suppliers |
|---|---|
| Nygen 910 | Nynas AB |
| Regenis | Total |
| Reclamite | Tricor Refining |
| Cyclogen | Tricor Refining |
| Cecabase RWI | Arkema |
| ValAro | PBF Energy |
| Rheofalt HP-AM | BASF (Ventraco) |
| ReJUVN8 | Sripath Technologies |
| RePLAY 18 | BioSpan Technologies |
| BituTech RAP | Engineered Additives |
| Hydrogreen S | PVS Meridian |
| Biorestor | BioBased Spray |
| SylvaRoad RP1000 | Kraton |
| Evoflex | Ingevity |
| Delta S | Collaborative Aggregates |
| Bioflux | Neste |
| Storbit | Storimpex Asphaltec |
| Ravasol RAP-5V | Ravago Chemicals |
| AXMAT 1000EK | Axaria and Materia |

In some cases, rejuvenators are derived from pine-oil, for example:
Evoflex® commercially available from Ingevity, in particular Evoflex CA3 and Evoflex CA8;
Sylvaroad® commercially available from Kraton, in particular Sylvaroad RP1000.
Ravasol® commercially available from Ravago Chemicals, in particular Ravasol RAP-5V

In some cases, rejuvenators are derived from vegetable oils, for example:
AXMAT® commercially available from Axaria and Materia, in particular AXMAT 1000EK

In some case, the rejuvenator is derived from crude oil:
Regenis® commercially available from Total, in particular Regenis 50;
Cecabase® commercially available from Arkema, in particular Cecabase RWI

Particularly preferred rejuvenators are:
Evoflex® commercially available from Ingevity;
Sylvaroad® commercially available from Kraton.
Ravasol® commercially available from Ravago Chemicals
AXMAT® commercially available from Axaria and Materia

Desirably the rejuvenator is not cooking oil.

### Amount of Rejuvenators

Since rejuvenators are expensive ingredients, the rejuvenator which produces the highest viscosity decrease and the high cold flexibility increase at low quantities are preferred.

Accordingly, the amount (concentration) of the rejuvenator is from 0.4 w % to 15 w %, preferably from 0.8 w % to 12 w %, even more preferably from 1.2 w % to 8 w % as compared to the total weight of the bituminous binder.

### Ratio of Rejuvenators to Recycled Bituminous Binders

Desirably, the weight-ratio between rejuvenators and recycled bituminous binder is from 0.005 to 0.200, preferably from 0.010 to 0.150, even more preferably from 0.015 to 0.100.

### Recycled Oil

The bituminous binder comprising the recycled bituminous binder may further comprise recycled oil, for example recycled industrial oil.

Optionally, recycled oil is obtained via the re-refining of waste mineral lubricating coils. Typical examples of waste mineral lubricating oils are engine oil, hydraulic oils or machinery lubricants.

Recycled oil is commercially available, for example under the brand names:
Avista BII (from Avista Oil AG),
Osi 935 (from Osilube),
FCFDR (from R.A.M. Oil),
Bitumen Flux (from STR Tecoil Oy),
Eco Huile 700SR (from Eco Huile),
Purabit H2 (from Puraglobe GMBH),
Viscoflex 1000 (from Itelyum),
Viscoflex 2000 (from Itelyum),
Basol T (from HFM Fuhse Raffinerie)

Optionally, the recycled oil is not cooking oil.

The bituminous binder comprising the recycled bituminous binder typically comprises recycled oil in an amount from 0.5 w % to 20 w % such as from 1 w % to 20 w %, preferably from 1 w % to 18 w % such as from 1.5 w % to 18 w %, even more preferably from 1.5 w % to 16 w % such as from 2 w % to 16 w % as compared to the weight of the bituminous binder.

### Thickness of the Waterproofing Membrane

The recyclable waterproofing membrane may have a thickness of 1 mm to 6 mm, preferably from 1.5 mm to 5 mm, such as from 2 mm to 5 mm, such as between 2.5 mm and 5 mm and even more preferably between 3 mm to 5 mm.

Optionally, the recyclable waterproofing membrane is a multilayer waterproofing membrane.

### Polymers

A wide variety of polymers is suitable for the present disclosure such as polyolefin or styrene-based copolymers.

Preferred polymers are poly(ethylene), polypropylene (atactic, isotactic or syndiotactic), poly(styrene-butadiene-styrene), poly(styrene-isoprene-styrene), poly(styrene-ethylene-butylene-styrene).

Optionally, the polymer is chosen from the group consisting of poly(ethylene vinyl acetate) (PEVA), polybutene (PB), polyisobutene (PIB).

### Polymers Present in the RBB

Optionally, polymers are present in the recycled bituminous binder (RBB polymers).

Desirably, the RBB polymer is a polyolefin. Optionally, the polyolefin is present in the recycled bituminous binder in an amount from 1 w % to 21 w %, preferably from 3 w % to 19 w %, even more preferably from 5 w % to 17 w % as compared to the total weight of the bituminous binder.

Additionally or alternatively, the RBB polymer may be a styrene-based polymer. Optionally, the styrene-based polymer is present in the recycled bituminous binder in an amount from 0.5 w % to 11 w %, preferably from 1 w % to 10 w %, even more preferably from 1.5 to 9 w % as compared to the total weight of the bituminous binder.

### Added Polymers

Optionally, polymers are added to the bituminous binder (added polymers).

Optionally, the added polymer is a polyolefin. Desirably, the polyolefin is added to the bituminous binder (which comprises the recycled bituminous binder) in an amount from 0.5 w % to 15 w %, such as from 1 w % to 15 w %, preferably from 0.5 w % to 13 w %, such as from 1.5 w % to 13 w %, even more preferably from 0.5 w % to 11 w %, such as from 3 w % to 11 w % as compared to the total weight of the bituminous binder.

Additionally or alternatively, the added polymer is a styrene-based polymer. Optionally, the styrene-based polymer is added to the bituminous binder comprising recycled bituminous binder in an amount from 0.3 w % to 8 w %, preferably from 0.5 w % to 7 w %, even more preferably from 0.5 to 6 w %, such as from 1 w % to 6 w % as compared to the total weight of the bituminous binder.

### Total Amount of Polymers in the Bituminous Binder

Optionally, the waterproofing membrane comprises (fresh) polymers added to the bituminous binder and polymers from the recycled bituminous binder.

Desirably, both the added and the RBB polymer are polyolefins. Suitably, the (total) polyolefin (added and present in the RBB) content is from 10 w % to 30 w %, preferably from 15 w % to 25 w %, even more preferably from 18 w % to 22 w % as compared to the total weight of the bituminous binder.

Additionally or alternatively, both the added and the RBB polymer are styrene-based polymers. Optionally, the (total) styrene-based polymer (added and present in the RBB) content is from 3 w % to 12 w %, preferably from 4 w % to 10 w %, even more preferably from 5 w % to 9 w % as compared to the total weight of the bituminous binder.

### Other Agents

Other agents may be present in the bituminous binder, for example a fire-resistance agent or an anti-root agent or a combination thereof. Such agents are typically present in an amount of 0.10 w % to 40 w % of the bituminous binder.

### Reinforcement

Optionally, the reinforcement is immersed in the recycled bituminous binder.

Suitable reinforcements include non-woven, woven, scrim, yarn or a combination thereof. Preferably, the reinforcement is made of polyester, glass or a combination thereof.

Optionally, the recyclable waterproofing membrane comprises two reinforcements.

### Self-Adhesive

Optionally, the bituminous binder is self-adhesive.

### Viscosity

The dynamic viscosity is measured at 180° C. via an Anton Paar rheometer Physica MCR 102 equipped with two plates spaced by 1.3 mm.

### Flexibility

The cold flexibility is measured according to the standard EN1109 using 5×20 cm specimens and a BDA bending test apparatus. Ethylene glycol-cooled dilution is performed as suggested in EN 1109 for ethanol (1 solvent/1 water). The cold flexibility is assessed by visual inspection of cracks after bending. (Unless otherwise stated all values given for the present disclosure relate to the cold flexibility.)

### Penetrability

Penetrability is measured according to the standard ASTM-D5 using 5×5×5 cm specimen (immerged at least 1 h at 25° C. in a water bath) and a penetrometer PNR12 from Anton Paar. Penetrations are made on the underside of the specimens.

### Manufacturing Cost

The manufacturing cost of the recyclable waterproofing membranes of the disclosure is decreased for the following reasons:
the increased level of recycled bituminous binder decreases the need for fresh bitumen; and
through the increased level of recycled bituminous binder decreases the need for polymers since the recycled bituminous binder already contains polymers.
Through the addition of rejuvenator, the need for extra added polymer is reduced.

### Examples

An overview of the performance properties of the recycled bituminous waterproofing membranes is shown in Table 1. The recycled bituminous binder (RBB) has been obtained by recycling of membranes through the process described in the claims of patent EP3852932B1 (they may also be obtained by recycling of membranes through the process described in the claims of patent EP3853306B1). The recycled oil (RO) has been provided under the trade name AVISTA B II. Evoflex® is a commercially available pine-oil-based rejuvenator.

The bituminous binder has been obtained by mixing the RBB, the RO and the rejuvenator at 180° C. during 2 h with an IKA Eurostar 60 stirrer at 1000 RPM.

Table 1 shows the influence of different amounts (concentrations) of rejuvenators on the viscosity, penetrability and cold flexibility of the RBB combined with RO (Binder 3 to 20) as compared to the RBB with RO without rejuvenator (Binder 2). As of a ratio rejuvenator/RBB above 0, the addition of a rejuvenator enabled to improve the cold flexibility of the bituminous binder as well as the penetrability. The best improvements were obtained with Evoflex CA3 and Evoflex CA8. On top of the improvements mentioned above, Evoflex CA3 and Evoflex CA8 enabled to effectively decrease the viscosity (improved processability) while increasing the cold flexibility.

TABLE 1

| | | | | | | Viscosity | | |
|---|---|---|---|---|---|---|---|---|
| | | | | | | at 180° C. | Penetrability | Cold |
| | RBB | RO | Rejuvenator | Rejuvenator/ | Rejuvenator | (in | at 25° C. (in | Flexibility |
| | (w %) | (w %) | (w %) | RBB | Name | mPa · s) | dmm) | (in ° C.) |
| Binder 1 | 90.0 | 10.0 | 0.0 | 0.000 | / | 21272 | 10 | −16 |
| Binder 2 | 100.0 | 0.0 | 0.0 | 0.000 | / | 20400 | 17 | −8 |
| Binder 6 | 88.4 | 10.0 | 1.6 | 0.018 | Cecabase | 15852 | 32 | −18 |
| | | | | | RWI | | | |
| Binder 7 | 86.8 | 10.0 | 3.2 | 0.037 | Cecabase | 17350 | 33 | −17 |
| | | | | | RWI | | | |
| Binder 8 | 85.1 | 10.0 | 4.9 | 0.057 | Cecabase | 19584 | 34 | −20 |
| | | | | | RWI | | | |
| Binder 9 | 88.4 | 10.0 | 1.6 | 0.018 | Evoflex CA3 | 21700 | 31 | −14 |
| Binder 10 | 86.8 | 10.0 | 3.2 | 0.037 | Evoflex CA3 | 11726 | 28 | −21 |
| Binder 11 | 85.1 | 10.0 | 4.9 | 0.057 | Evoflex CA3 | 10289 | 31 | −26 |
| Binder 12 | 88.4 | 10.0 | 1.6 | 0.018 | Evoflex CA8 | 18900 | 31 | −14 |
| Binder 13 | 86.8 | 10.0 | 3.2 | 0.037 | Evoflex CA8 | 11522 | 32 | −28 |
| Binder 14 | 85.1 | 10.0 | 4.9 | 0.057 | Evoflex CA8 | 16100 | 31 | −27 |
| Binder 15 | 88.4 | 10.0 | 1.6 | 0.018 | Regenis 50 | 29560 | 31 | −12 |
| Binder 16 | 86.8 | 10.0 | 3.2 | 0.037 | Regenis 50 | 21800 | 31 | −17 |
| Binder 17 | 85.1 | 10.0 | 4.9 | 0.057 | Regenis 50 | 24041 | 32 | −20 |
| Binder 18 | 88.4 | 10.0 | 1.6 | 0.018 | Sylvaroad | 20400 | 32 | −21 |
| | | | | | RP1000 | | | |
| Binder 19 | 86.8 | 10.0 | 3.2 | 0.037 | Sylvaroad | 17200 | 36 | −28 |
| | | | | | RP1000 | | | |
| Binder 20 | 85.1 | 10.0 | 4.9 | 0.057 | Sylvaroad | 20911 | 34 | −24 |
| | | | | | RP1000 | | | |

Table 2 shows the influence of different amounts (concentrations) of rejuvenators on the viscosity, penetrability and cold flexibility of the RBB (Binder 21 to 24) as compared to the RBB without rejuvenator (Binder 2). The addition of a rejuvenator enabled to improve the cold flexibility of the bituminous binder as well as the penetrability and to decrease the viscosity. On top of that, Table 2 shows that the addition of a rejuvenator is effective without the addition of a recycled oil.

TABLE 2

| | | | | | | Viscosity | | Cold |
|---|---|---|---|---|---|---|---|---|
| | RBB | RO | Rejuvenator | Rejuvenator/ | Rejuvenator | @ 180° C. | Penetrability | Flexibility |
| | (w %) | (w %) | (w %) | RBB | Name | (in mPa · s) | (in dmm) | (in ° C.) |
| Binder 1 | 90.0 | 10.0 | 0.0 | 0.000 | / | 21272 | 10 | −16 |
| Binder 2 | 100.0 | 0.0 | 0.0 | 0.000 | / | 20400 | 17 | −8 |
| Binder 23 | 96.4 | 0.0 | 3.6 | 0.037 | Evoflex CA8 | 7907 | 25 | −24 |
| Binder 24 | 94.6 | 0.0 | 5.4 | 0.057 | Evoflex CA8 | 6640 | 32 | −22 |

In additional tests the following observations were made.

When introducing up to 15 w % of fresh polymer and incorporating up to 10 w % of filler into Binder 13 (which includes rejuvenator), a notable enhancement in toughness is observed, while the cold flexibility remains unaffected. It is important to note that insufficient toughness can result in a binder that's prone to brittleness, ultimately compromising the membrane's overall durability.

When introducing up to 15 w % of fresh polymer and incorporating up to 10 w % of filler into Binder 13 (which includes rejuvenator) and replacing Evoflex CA8 by Ravasol RAP-5V or AXMAT 1000EK similar improvements in cold flexibility, penetration and viscosity were observed.

Conversely, the scenario changes when augmenting Binder 1 (which does not include rejuvenator) with up to 15 w % of fresh polymer and up to 10 w % of filler. In this case, no improvement in toughness is observed, and the cold flexibility actually deteriorates. This suggests potential compatibility issues among the constituents.

Similarly, when integrating up to 15 w % of fresh polymer and up to 10 w % of filler into Binder 16, compatibility problems arise, leading to a resulting material that displays brittleness. This may be due to the fact that Binder 16 has a mineral oil.

1-16. (canceled)

17. A recyclable waterproofing membrane, comprising:
a. a bituminous binder comprising a recycled bituminous binder (RBB), optionally a fresh polymer and optionally fresh bitumen; and
b. a reinforcement;
wherein the bituminous binder comprises a rejuvenator selected from the group consisting of bio-based oils and/or mineral; and
wherein the cold flexibility of the bituminous binder is from −10° C. to −35° C.; and
optionally wherein the recycled bituminous binder is obtained by grinding and melting waterproofing membranes comprising bituminous binder, polymers and a reinforcement.

18. The recyclable waterproofing membrane according to claim 17, wherein the weight ratio of the rejuvenator to recycled bituminous binder (Rejuvenator/RBB) is from 0.005 to 0.200.

19. The recyclable waterproofing membrane of claim 17, wherein the polymer is a polyolefin or a styrene-based polymer.

20. The recyclable waterproofing membrane according to claim 17, wherein the amount of added polyolefin polymer in the bituminous binder is from 0.5 w % to 15 w % as compared to the total weight the bituminous binder.

21. The recyclable waterproofing membrane according to claim 17, wherein the amount of added styrene-based polymer in the bituminous binder is from 0.3 w % to 8 w % as compared to the total weight of the bituminous binder.

22. The recyclable waterproofing membrane according to claim 17, wherein the amount of the rejuvenator is from 0.4 w % to 15 w % as compared to the total weight of the bituminous binder.

23. The recyclable waterproofing membrane according to claim 17, wherein the recycled bituminous binder further comprises recycled oil, preferably obtained by re-refining of waste mineral lubricating oils

24. The recyclable waterproofing membrane according to claim 17, wherein the bituminous binder further comprises recycled oil in an amount from 0.5 w % to 20 w % as compared to the total weight of the bituminous binder.

25. The recyclable waterproofing membrane according to claim 17, wherein the thickness, d, of the recyclable waterproofing membrane is between 1 mm and 6 mm.

26. The recyclable waterproofing membrane according to claim 17, wherein the reinforcement is a non-woven fabric.

27. The recyclable waterproofing membrane according to claim 17, wherein the reinforcement is made of polyester, glass fiber or a combination thereof.

28. The recyclable waterproofing membrane according to claim 17, wherein the bituminous binder comprises fresh bitumen and the fresh bitumen is present in an amount up to 75 w % as compared to the total weight of the bituminous binder

29. A process for manufacturing a recyclable bituminous waterproofing membrane according claim 17, wherein the bituminous binder is obtained by a process comprising the steps of:
Finely grinding bituminous waterproofing membranes; wherein the bituminous waterproofing membranes comprise bituminous binder, polymers and a reinforcement;
Introducing the finely ground batch into a recycling unit having at least a rotor and a stator and an micronization chamber, wherein the fine ground batch is heated and melted by shear strength upon the operation of the stator, rotor and micronization chamber;
Optionally, diluting the melted product in a mixing tank containing fresh bitumen and/or recycled oil up to a factor 2 at a residence temperature comprised between 160° C. and 200° C. wherein a rejuvenator is added to decrease the viscosity at 180° C., so that after the rejuvenator is added the viscosity is from 5000 mPa·s to 25000 mPa·s.

30. A process for manufacturing a recyclable bituminous waterproofing membrane according to claim 17, wherein the bituminous binder is obtained by a process comprising the steps of:
Finely grinding bituminous waterproofing membranes; wherein the bituminous waterproofing membranes comprise bituminous binder, polymers and a reinforcement;
Introducing the finely ground batch into a recycling unit having at least a rotor and a stator and an micronization chamber, the fine ground batch is heated and melted by shear strength upon the operation of the stator, rotor and micronization chamber;
Optionally, diluting the melted product in a mixing tank containing fresh bitumen and/or recycled oil up to a factor 2 at a residence temperature comprised between 160° C. and 200° ca rejuvenator is added to decrease the viscosity at 180° C., so that after the rejuvenator is added the viscosity is from 5000 mPa·s to 25000 mPa·s; and
feeding the melted product in a mixing tank containing fresh bitumen between 15 w % and 50 w % at a residence temperature comprised between 160° C. and 200° C. until the melted product is between 50 w % and 95 w %, wherein a rejuvenator is added to decrease the viscosity at 180° C., so that after the rejuvenator is added the viscosity is from 5000 mPa·s to 25000 mPa·s.

31. A process for improving the performance of recyclable waterproofing membranes comprising a recycled bituminous binder and a reinforcement, wherein a rejuvenator is added to the recycled bituminous binder, and wherein the cold flexibility of the bituminous binder comprising the rejuvenator is from −10° C. to −35° C. and optionally for one or more of:
Regenerating the polymer;
Decreasing the viscosity, for decreasing the viscosity of the bituminous binder comprising the RBB wherein the viscosity is decreased to be 5000 mPa·s to 25000 mPa·s; or
Increasing the penetrability at 25° C., from 25 dmm to 40 dmm;
wherein the rejuvenator is selected from the group consisting of bio-based oils and mineral oils;
wherein the recycled bituminous binder is obtained by grinding and melting waterproofing membranes comprising bituminous binder, polymers and a reinforcement.

32. A method of using a rejuvenator:
wherein the rejuvenator is part of the recycled bituminous binder, and wherein the cold flexibility of the bituminous binder comprising the rejuvenator is from −10° C. to −35° C. and optionally for one or more of:
Regenerating the polymer;
Decreasing the viscosity, for decreasing the viscosity at 180° C. of the recycled bituminous waterproofing membranes to 5000 mPa·s to 25000 mPa·s; or
Increasing the penetrability at 25° C., from 25 dmm to 40 dmm;
in recycled bituminous binders;
wherein the rejuvenator is selected from the group consisting of bio-based oils and mineral oils;
wherein the recycled bituminous binder is obtained by grinding and melting waterproofing membranes comprising bituminous binder, polymers and a reinforcement.
